(19) United States
(12) Patent Application Publication
(10) Pub. No.: US 2002/0067894 A1
(43) Pub. Date: Jun. 6, 2002

(54) Ferrule having bondable insert

(76) Inventor: Thomas Scanzillo, Trumbull, CT (US)

Correspondence Address: CANTOR COLBURN, LLP, 55 GRIFFIN ROAD SOUTH, BLOOMFIELD, CT, 06002

(21) Appl. No.: 09/927,678

(22) Filed: Aug. 10, 2001

Related U.S. Application Data
(60) Provisional application No. 60/225,116, filed on Aug. 14, 2000.

(51) Int. Cl. G02B 6/36

(52) U.S. Cl. 385/80; 385/86

(57) ABSTRACT

A connector is disclosed for use with a fiber optic cable. The connector of the present invention includes a housing portion having a first end and a second end, the first end for mating with a second connector, the second end for receiving the fiber optic cable, the housing further including a cavity formed therein. A strain relief member communicates between the second end of the housing and the fiber optic cable for providing support therebetween. The connector further includes a lead-in tube disposed in the cavity, the lead-in tube having first fiber passageways formed therein. A ferrule is disposed in the cavity adjacent the lead-in tube. The ferrule includes a removable insert, the insert having second fiber passageways formed therein. The ferrule insert is further composed of a material which readily bonds with a quick-curing adhesive.

### CROSS-REFERENCE TO RELATED APPLICATIONS

This application claims the benefit of U.S. provisional patent application serial No. 60/225,116, filed Aug. 14, 2000, the entire contents of which are incorporated herein by reference.

### BACKGROUND OF THE INVENTION

An optical connector arrangement 10, as shown in FIGS. 1 and 2, generally provides an arrangement for the mating of optical fibers, particularly, the mating of two pairs of optical fibers. Arrangement 10 includes connectors 12 which mate at an adapter 14.

Connector 12 generally includes a housing 16 having a lead-in tube 18 releasably connected therein and extending from a rear portion of housing 16. Lead-in tube 18 is fitted with a spring 20. Lead-in tube 18, spring 20, and the rear portion of connector housing 16 are mounted within a strain relief boot 22 to form connector 12. A fiber optic cable 24 is terminated at connector 12 such that fibers 26 are passed through lead-in tube 18 and connector housing 16, extending therefrom for mating within adapter 14.

Connector 12 further includes a ferrule 28 located within connector housing 16. Ferrule 28 contains fibers 26 and allows passage there through to the exterior of connector housing 16. At a back end 30, ferrule 28 communicates with lead-in tube 18. At a front end 32, ferrule 28 emerges from connector housing 16 exposing fibers 26. Fibers 26 may be cleaved and polished as known in the art. Connector housing 16 and ferrule 28 are typically formed of a plastic material. Ferrule 28 may be integral with connector housing 16 or ferrule 28 may be slidably received by connector housing 16.

Fibers 26 are seated within ferrule 28 by an adhesive bonding process. First, an adhesive epoxy is mixed. The epoxy is then loaded into a syringe. The syringe is used to inject the epoxy into back end 30 of ferrule 28. Fibers 26 are inserted into ferrule 28 such that the fibers 26 protrude from front end 32 of ferrule 28 by typically ½ inch. Cable 24 is properly seated and mated with connector housing 16, lead-in tube 20, and strain relief boot 22. Now fibers 26 are disposed within ferrule 28 and are coated and surrounded by the injected adhesive epoxy. Further cable 24 is connectorized with connector 12.

The next step in the process of adhesively bonding fibers 26 within ferrule 28 is the curing of the epoxy. The connectorized connector 12 is installed into a curing holder. The curing holder serves to protect fibers 26 protruding from connector housing 16 from damage that could occur from handling during curing of the epoxy. Connector 12 and the curing holder are placed into a curing oven. The curing oven, generally, includes a hot plate having approximately 12 to 20 holes formed therein for receiving connector 12 and the curing holder. Connector 12 is subjected to a predetermined temperature for a predetermined time period, thus curing the adhesive epoxy located within ferrule 28 and securing fibers 26 therein.

The remaining steps of the bonding process involve cleaning and preparing front end 32 of ferrule 28. Fibers 26 protruding from connector housing 16 are cleaved using a pocket pen style scriber, removing the cleaved portion of fibers 26 with a straight, non-twisting pull, and disposing of the removed portion. Then, excess epoxy is removed from front end 32 of ferrule 28 using a relatively coarse grit polishing film. The tips of fibers 26 protruding from ferrule 28 are polished to a desired smoothness using increasingly finer grit films. Finally, front end 32 of ferrule 28 and the exposed portion of fibers 26 are cleaned, connector 12 is inspected, tested, and placed into use.

The process of adhesively bonding fibers 26 within ferrule 28 is neither convenient nor economical for field terminations of connector 12. As mentioned, this process requires an installer to use an oven to cure the epoxy. The oven constitutes an additional piece of equipment to be purchased, maintained, and carried by the installer, thus adding to the cost and heightening the inconvenience of terminating connectors 12. Further, use of the oven presents the installer with added concerns of personal and work place safety due to heightened temperatures associated with curing oven operation. Additionally, the curing time of adhesive epoxies used with plastic ferrule 28 can be excessive causing termination delays reducing overall installation efficiency. For instance, a typical adhesive epoxy takes one-half hour to cure in a curing oven at 120° C.

Thus, it would be advantageous to have a fiber optical connector having a ferrule capable of fiber installation in a short time period and without the use of high temperature curing ovens.

### SUMMARY OF THE INVENTION

A connector is disclosed for use with a fiber optic cable. The connector of the present invention includes a housing portion having a first end and a second end, the first end for mating with a second connector, the second end for receiving the fiber optic cable, the housing further including a cavity formed therein. A strain relief member communicates between the second end of the housing and the fiber optic cable for providing support therebetween. The connector further includes a lead-in tube disposed in the cavity, the leadin tube having first fiber passageways formed therein.

A ferrule is disposed in the cavity adjacent the lead-in tube. The ferrule includes a removable insert, the insert having second fiber passageways formed therein. The ferrule insert is further composed of a material which readily bonds with a quick-curing adhesive.

The fibers pass from the cable into the cavity at the second end of the housing where the fibers pass through the first and second fiber passageways to the first end of the housing for mating with the second connector. The fiber is bonded within the second fiber passageway to the insert using a quick drying adhesive.

The ferrule with bondable insert of the present invention allows a convenient and simple means of setting optical fibers within the ferrule and further provides for the efficient termination of a fiber connector. The exemplary ceramic composition of the ferrule serves as an appropriate substrate to allow bonding of optical fiber thereto using a quick-curing adhesive agent. Thus, no oven or associated elevated temperatures are necessary in the setting of the fibers reducing complexity of the process and ensuring worker and workplace safety. Yet, the ferrule, itself, remains of a plastic composition, retaining functionality within the fiber optic connector.

### BRIEF DESCRIPTION OF THE DRAWINGS

Referring now to the drawings wherein like elements are numbered alike in the several FIGURES:

FIG. 1 is a perspective view of a conventional fiber optic connector arrangement;

FIG. 2 is a cross-sectional view of a fiber optic connector of FIG. 1;

FIG. 3 is a front perspective view of one embodiment of a fiber optic connector according to the present invention;

FIG. 4 is a rear perspective view of the fiber optic connector of FIG. 3;

FIG. 5 is a front perspective exploded view of the fiber optic connector of FIG. 3;

FIG. 6 is a front elevational view of the fiber optic connector of FIG. 3;

FIG. 7 is a cross-sectional view of the fiber optic connector of FIG. 6 along line 7-7;

FIG. 8 is a cross-sectional view of the fiber optic connector of FIG. 6 along line 8-8;

FIG. 9 is a perspective view of one embodiment of a ferrule according to the present invention;

FIGS. 10-11 are side elevational views of the ferrule of FIG. 9;

FIG. 12 is a front elevational view of the ferrule of FIG. 9;

FIG. 13 is a rear elevational view of the ferrule of FIG. 9;

FIG. 14 is a cross-sectional view of the ferrule of FIG. 13 along line 14-14;

FIG. 15 is an enlarged view of the ferrule of FIG. 14;

FIG. 16 is a front perspective view of one embodiment of the ferrule insert of FIG. 13;

FIG. 17 is a front elevational view of the ferrule insert of FIG. 16;

FIG. 18 is a cross-sectional view of the ferrule insert of FIG. 17 along line 18-18;

FIGS. 19-20 are various enlarged views of the ferrule insert of FIG. 18; and

FIG. 21 is an elevational view of a partially stripped fiber optic cable.

### DETAILED DESCRIPTION OF THE PREFERRED EMBODIMENTS

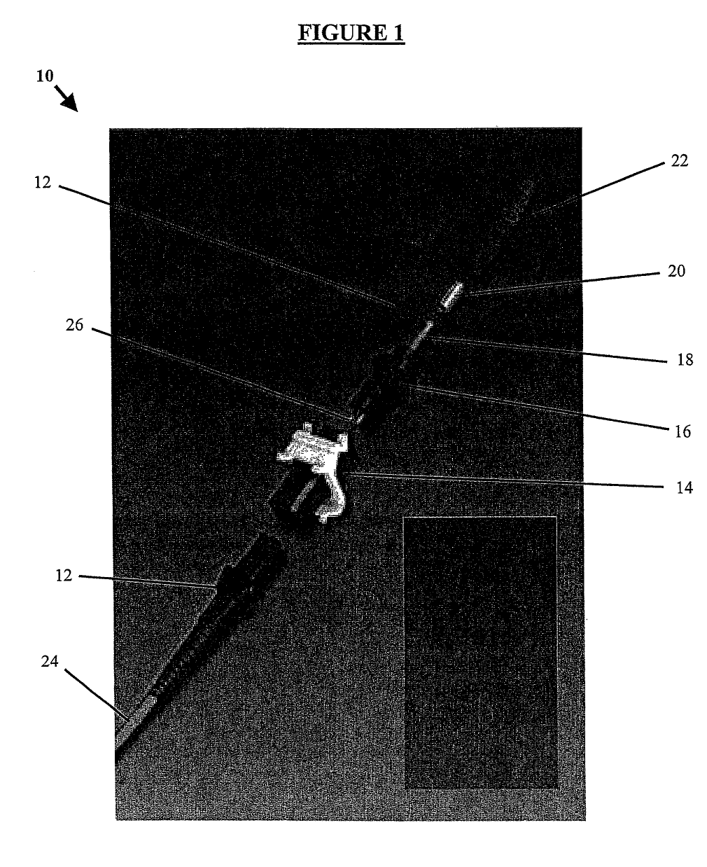

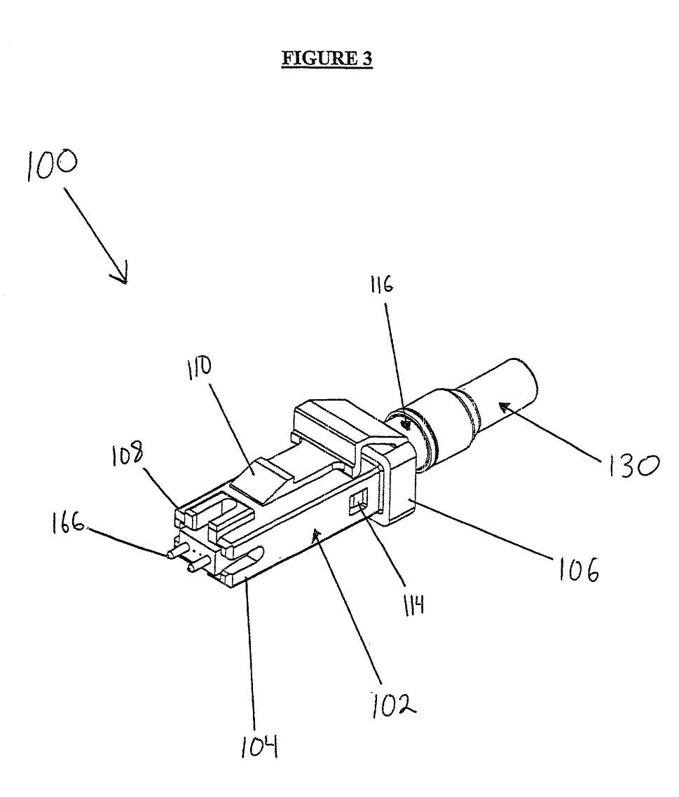

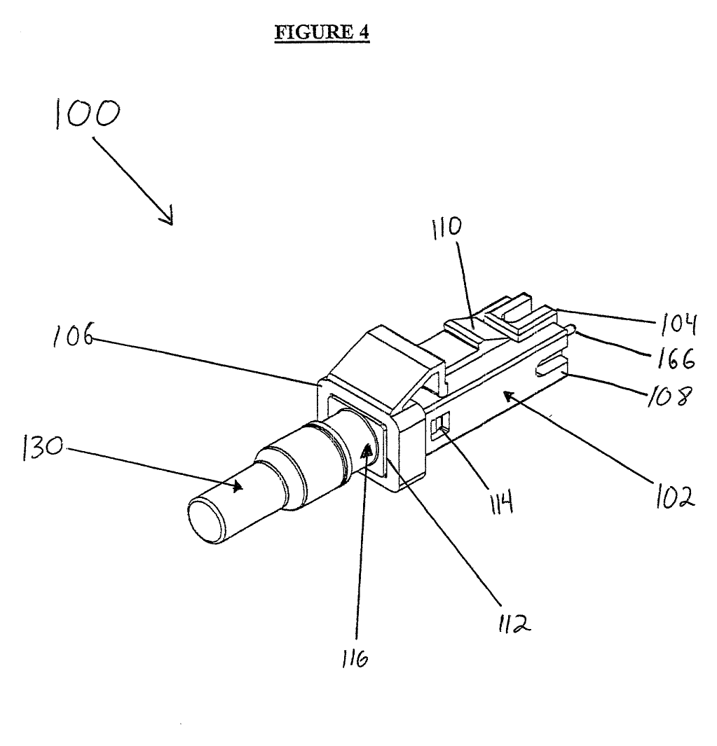

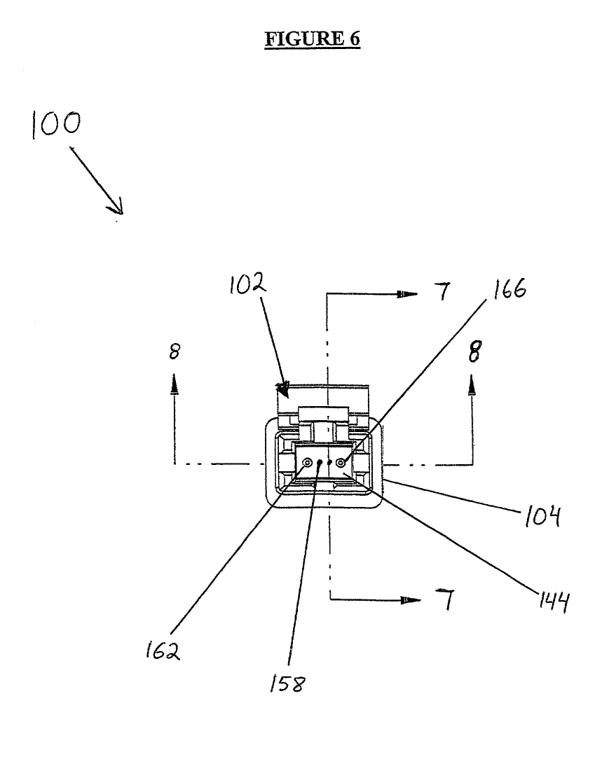

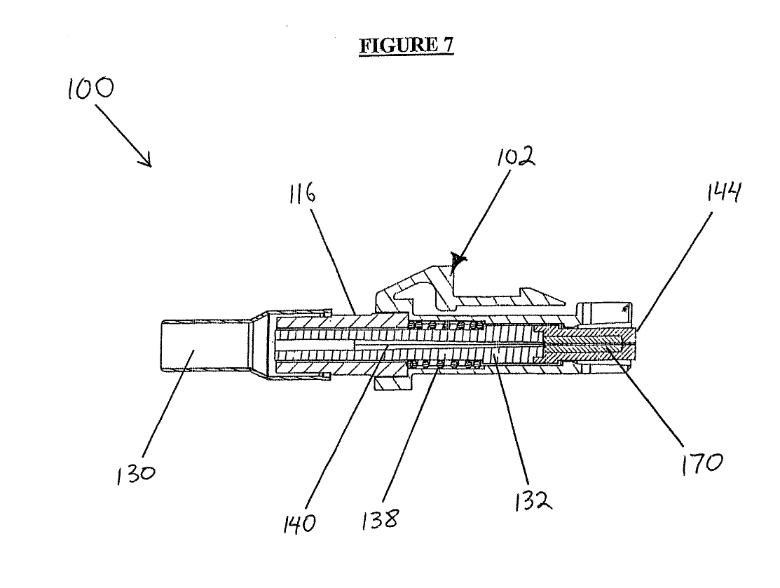

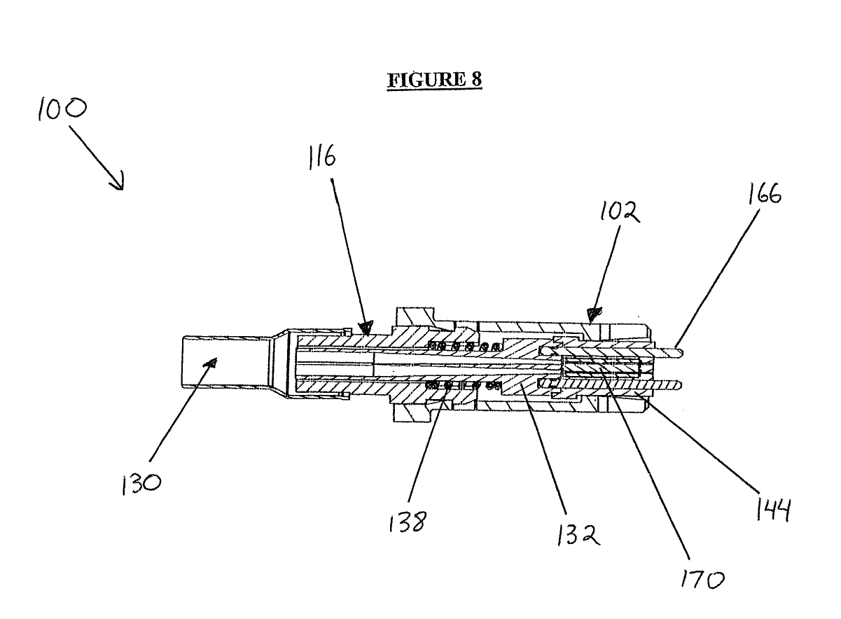

FIGS. 3-8 present various views of a fiber optic connector 100. Connector 100 includes a front housing 102 having a front end 104 and a rear end 106 located opposite one another. Front end 104 includes flanges 108 to facilitate mating connector 100 with a fiber optic adapter such as that shown in FIG. 1. Front housing 102 also includes a latching key 110 to further facilitate mating connector 100 with a fiber optic adapter. Rear end 106 of front housing 102 includes an opening 112 and latch holes 114 formed therein for receiving a rear housing 116 of connector 100. A passageway is formed on an interior of connector 100, traversing the length thereof from front end 104 to rear end 106.

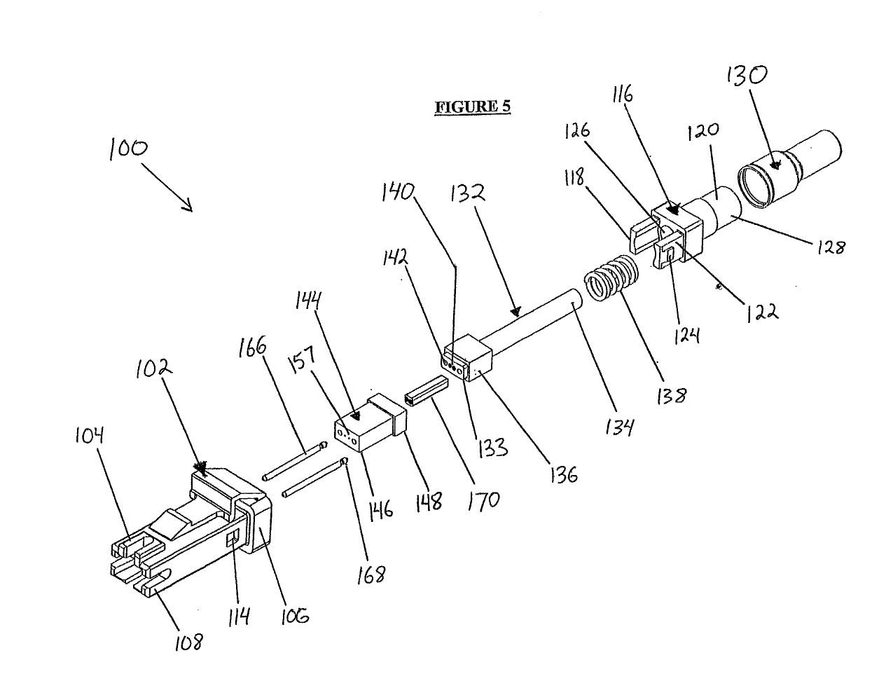

Rear housing 116, as best shown in FIG. 5, includes a front end 118 and an opposing rear end 120. Rear housing 116 includes extensions 122 having latch flanges 124 formed thereon, extensions 122 being located at front end 118. Extensions 122 are received by opening 112 of front housing 102 and latch flanges 124 are received by latch holes 114 to mate front and rear housing 102, 116.

Rear housing 116 also includes a passage way 126 traversing the length of the housing from front end 118 to rear end 120. Finally, rear housing 116 includes a cable portion 128 for mating with an unsheathed portion of a fiber optic cable as described in greater detail herein. A strain relief boot 130 fits over the cable portion 128 to enhance reception of and mating with an optical cable.

Fiber optic connector 100 further includes a lead-in tube 132, best shown in FIG. 5, having a tube portion 134 and an opposing plug portion 136. Tube portion 134 is received into passageway 126 of rear housing 116 upon assembling connector 100. A spring 138 is located about the tube portion 134 of lead-in tube 132 such that lead-in tube 132 and rear housing 116 interact elastically relative one another, biased about spring 138. Lead-in tube 132 includes fiber passages 140 formed therein from tube portion 134 to plug portion 136, through which optical fibers traverse the length of lead-in tube 132.

Plug portion 136 of lead-in tube 132 includes a raised portion 133 extending away from the plug portion. Raised portion 133 includes mating openings 142 formed therein to facilitate assemblage of the connector 100.

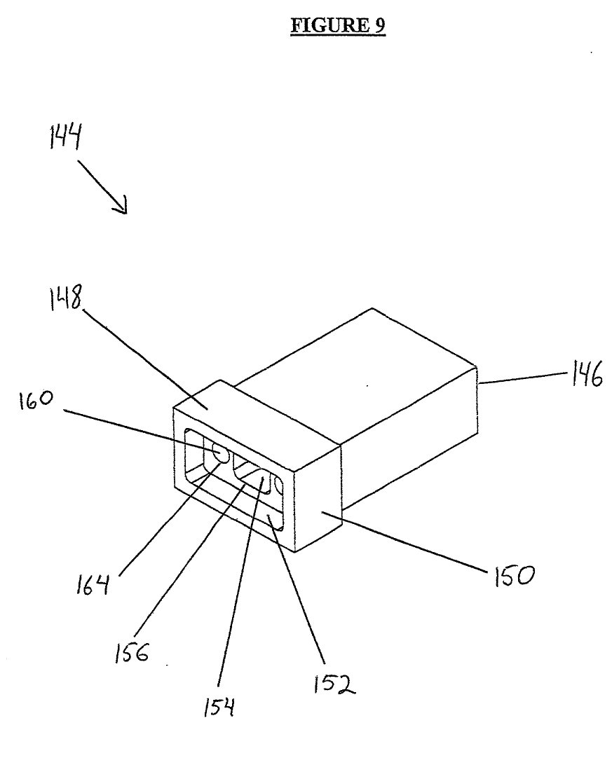

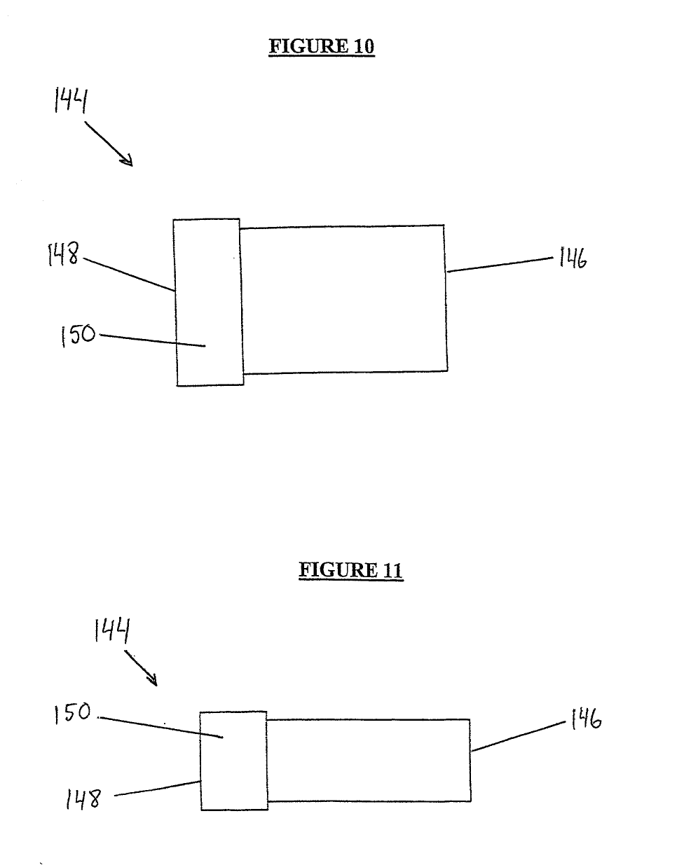

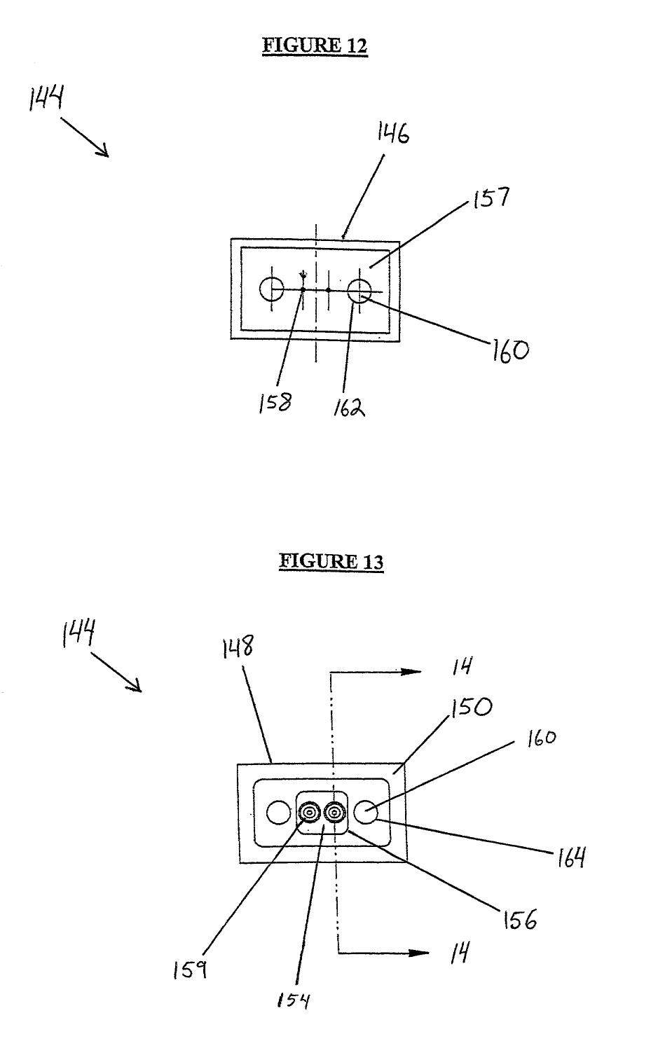

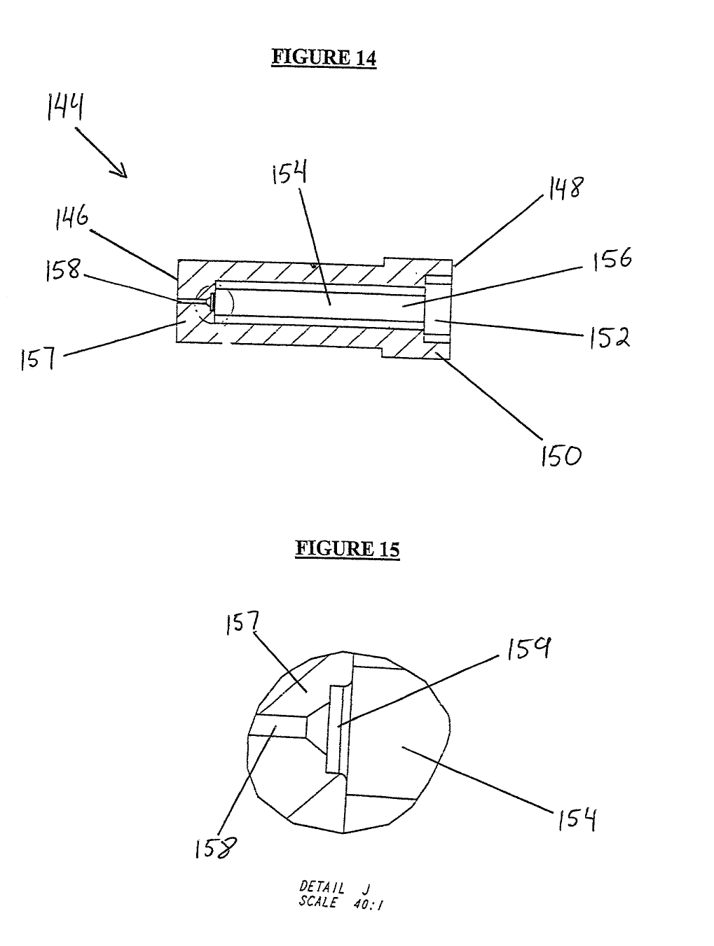

Fiber optic connector 100 additionally includes a ferrule 144 as shown in FIGS. 5-15. Ferrule 144 has opposing front and rear ends 146,148. Front end 146 is shaped and sized to be received through rear opening 112 of front housing 102 and retained in the passageway formed therein. Rear end 148 of ferrule 144 is shaped and sized to receive plug portion 136 of lead-in tube 132.

More specifically, rear end 148 of ferrule 144 includes a receptacle 150 having an opening 152 sized and shaped to receive raised portion 133 of lead-in tube 132. Ferrule 144 also includes an insert chamber 154 formed therein having an opening 156 located within receptacle 150. Insert chamber 154 extends the longitudinal length of ferrule 144 from rear end 148 to front end 146 where insert chamber 154 terminates at wall 157. Wall 157 is formed at front end 146 of ferrule 144 and serves as a partition between insert chamber 154 and an exterior of ferrule 144. Wall 157 includes a plurality of fiber bores 158 formed therein for allowing passage therethrough of optical fibers. Fiber bores 158 include funnel receptors 159 formed in wall 157 adjacent insert chamber 154 for facilitating reception of fibers within bores 158 and passage therethrough. Further, as discussed herein, funnel receptors 159 facilitate in assembling fiber optic connector 100. In an exemplary embodiment of the present invention, ferrule 144 includes two fiber bores 158 formed adjacent one another with two corresponding funnel receptors 159.

Adjacent and parallel to insert chamber 154, a plurality of post passageways 160 are formed in ferrule 144. Post passageways 160 extend the longitudinal length of ferrule 144 and have front openings 162 formed at front end 146 and rear openings 164 formed at rear end 148 within receptacle 150. In an exemplary embodiment, ferrule 144 is made of a plastic material.

Fiber optic connector 100 further includes alignment posts 166 as shown in FIGS. 3-6, and 8. Upon fully assembling fiber optic connector 100, posts 166 pass through and are retained within post passageways 160 of ferrule 144. Posts 166 thus extend from front and rear ends 146,148 of ferrule 144 a predetermined distance. Posts 166 include mating tips 168 which extend from rear end 148 of ferrule 144 and are received and retained within mating holes 142 of plug portion 136 of lead-in tube 132. Posts 166 serve to align, stabilize and secure the connection of lead-in tube 132 and ferrule 144. Additionally, posts 166 extending from front end 146 of ferrule 144 participate in connecting fiber optic connector 100 to another connector within a fiber optic adapter.

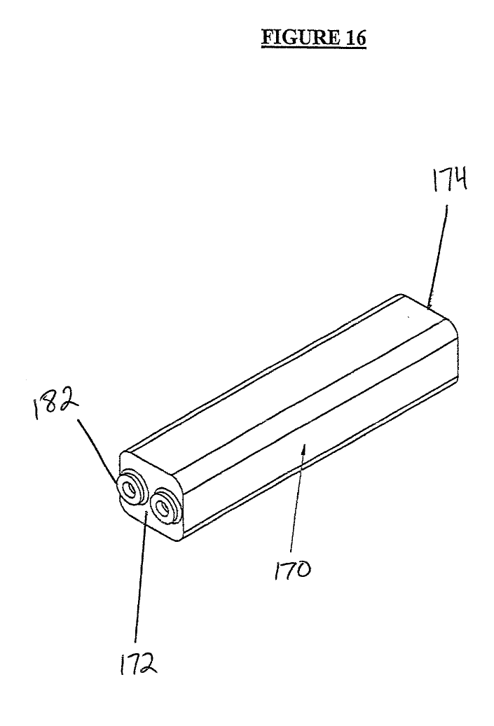

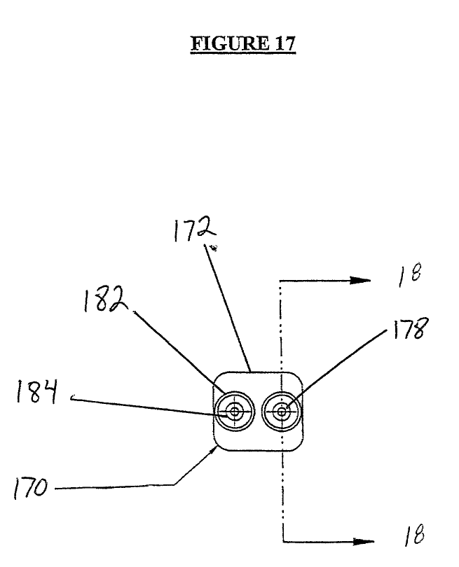

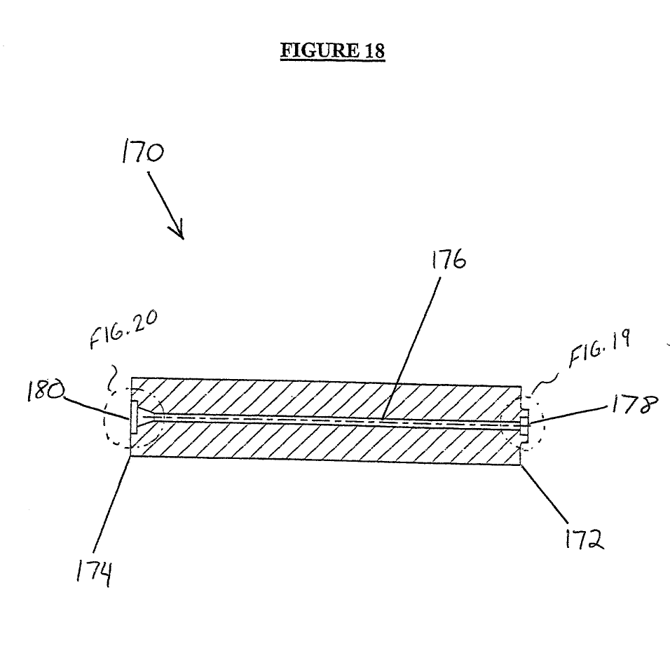

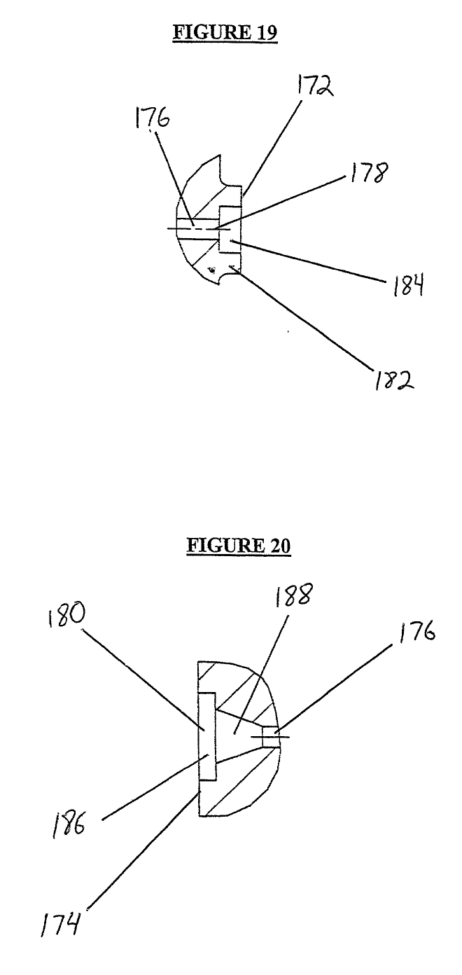

Fiber optic connector 100 additionally includes a ferrule insert 170 as shown in FIGS. 5-8, and 16-19. Ferrule insert 170 is generally sized and shaped to be received and retained within insert chamber 154 of ferrule 144. In an exemplary embodiment, ferrule insert 170 is an elongated rectilinear solid sized such that ferrule insert may be slidably received by ferrule 144 within insert chamber 154 and retained therein by resulting frictional forces.

Ferrule insert 170 includes a front end 172 and an opposing rear end 174. A plurality of fiber passageways 176 are formed within ferrule insert 170 and traverse the longitudinal length of ferrule 170 from front end 172 to rear end 174. In an exemplary embodiment of the present invention, ferrule insert 170 includes passageways 176 for two optical fibers. Fiber passageways 176 are generally circular in cross-section and have an area sufficient to contain optical fibers and a volume of adhesive agent necessary for bonding the fiber therein.

At front end 172, ferrule insert 170 includes front openings 178 of fiber passageways 176 which expose the passageways to the exterior of the insert. Similarly, rear openings 180 of fiber passageways 176 are located at rear end 174 of ferrule insert 170.

Front openings 178 include annular flanges 182 formed thereabout extending from ferrule insert 170. Front openings 178 include mouth portions 184 located within annular flanges 182. Mouth portions 184 are larger in cross-sectional area than that of fiber passageways 176. Annular flanges 182 and enlarged mouth portions 184 facilitate mating of ferrule insert 170 with ferrule 144 and passage of optical fibers therebetween, as discussed in greater detail herein.

In a preferred embodiment, rear openings 180 include a mouth portion 186 formed proximate rear end 174 and a funnel portion 188 formed distal rear end 174. Funnel portion 188 is frustoconical in shape with a tapered end in communication with fiber passageways 176. A cross-sectional area of mouth portions 186 of rear openings 180 is greater than the largest cross-sectional area of conically shaped funnel portion 188. Mouth and funnel portions 186, 188 of rear openings 180 aid in the reception of optical fibers into fiber passageways 176 and promote a delivery of the adhesive agent thereto.

In one embodiment, ferrule insert 170 is composed of a material which would perform adequately as a substrate for the adhesive agent and promote rapid curing thereof. Specifically, ferrule insert 170 is composed of a material to which a quick-cure adhesive would readily cure. Still more specifically, ferrule insert 170 is composed of ceramic or a ceramic composite or ceramic-like material. Alternatively, ferrule insert 170 may be made from glass or metal.

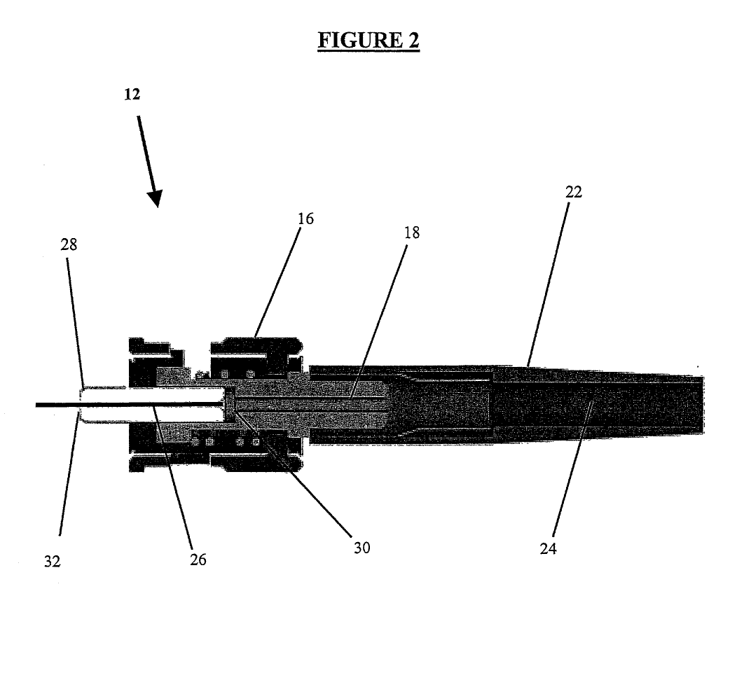

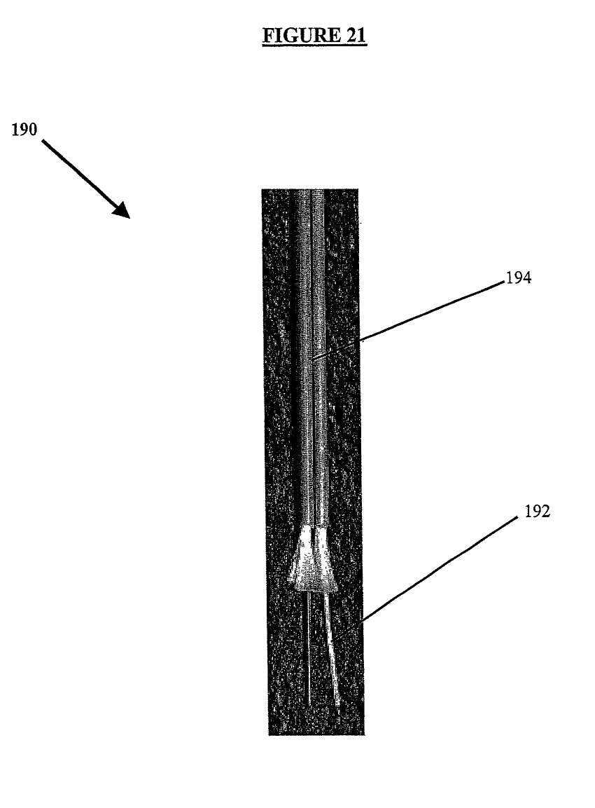

Now the assembling of fiber optic connector 100 and the termination of a fiber optic cable 190 therewith will be described with reference to FIGS. 1-21.

First, optical fibers 192 must be set within ferrule insert 170. Cable jacket and various insulating layers 194 are stripped from a desired portion of fiber optic cable 190 and, thus, fibers 192 exposed. Tube portion 134 of lead-in tube 132 is passed through spring 138 and enters passageway 126 of rear housing 116 and seats therein. Cable 190 is passed through strain relief boot 130 and brought proximate rear housing 116. Fibers 192 are inserted into passage 126 of rear housing 116 and therein fibers 192 are further inserted into passages 140 of lead-in tube 132. Fibers 192 are passed through the length of lead-in tube 132 until fibers 192 emerge from the plug portion 136. A sufficient length of fibers 192 is extended from lead-in tube 132.

A quick curing adhesive is now injected into fiber passageways 176 at rear end 174 of ferrule insert 170 in such a volume as to encapsulate fibers 192 upon insertion thereof into the passageways. Promptly, fibers 192 are inserted into rear openings 180 of ferrule insert 170. The mouth and funnel portions 186,188 of rear openings 180 facilitate ease of inserting fibers 192. Insertion of fibers 192 is continued until fibers 192 pass through the length of passageways 176 and emerge from the front openings 178 and extend from the ferrule insert a desired distance. The quick curing adhesive is allowed to cure.

The adhesive may be any of a plurality of quick-curing adhesives currently available. In a preferred embodiment, the quick-curing adhesive is one which would most effectively bond with ferrule insert 170 made of ceramic and fibers 192 of glass in the shortest amount of time. The adhesive may be an acrylic adhesive or a two-part acrylic adhesive. An exemplary quick curing adhesive is a two-part acrylic adhesive commercially available as the LIGHTSPEED (TM) adhesive, having an approximate curing time of thirty seconds.

The adhesive is preferably air cured and has a cure time between about 10 seconds and 60 seconds, and more specifically about 30 seconds. This provides rapid curing, but sufficient time for an installer to insert a fiber through the adhesive. Conventional adhesives having cure times of about 5 seconds can harden too quickly before the fiber is inserted through the ferrule. In this situation, the fiber end is trapped in the interior of the ferrule.

Accordingly, fibers 192 are now fixably set within ferrule insert 170. Preferably, ferrule insert 170 is positioned within ferrule 140 prior to application of the adhesive. Alignment posts 166 may also be position through front openings 162, passed through post passageways 160, and extended from rear openings 164. Fibers 192 extending from the ferrule 140 are subsequently cleaved and polished sufficiently so as to ultimately allow connection with another set of optical fibers in, for example, a fiber optic adapter.

Now, ferrule 144 is brought proximate lead-in tube 132 and positioned such that raised portion 133 of plug portion 136 is received within receptacle 150 of ferrule 144. In so doing, fiber passages 140 of lead-in tube 132 align with fiber passageways 176 of ferrule insert 170, the insert now being located within insert chamber 154 of ferrule 144. Mating tips 168 of alignment posts 166 are received and retained within mating holes 142 of lead-in tube 132. Thus, lead-in tube 132 and ferrule 144 are now releasably connected.

Next, front housing 102 is drawn toward rear housing 116 such that the ferrule/ferrule insert/lead-in tube assembly is received within the passageway in the interior of front housing 102. The ferrule/ferrule insert/lead-in tube assembly is inserted into front housing 102 until latch flanges of the rear housing snap-latch with latch holes 114 of the front housing. Alignment posts 166 and fibers 192 extend from front end 104 of housing 102. Fibers 192 are cleaved and polished at front end 104 of front housing 102 for connection with other optical fibers.

It is understood that the connector may be assembled using various ordering of steps. For example, the lead-in tube 132, ferrule 144, front housing 102 (and interior components) may be assembled prior to injecting the adhesive. In addition, the rear housing 116 and spring 138 may be joined to front housing 102 prior to injecting the adhesive. Thus, the order of assembly may vary.

The ferrule with bondable insert of the present invention allows a convenient and simple means of setting optical fibers within the ferrule and further provides for the efficient termination of a fiber connector. The exemplary ceramic composition of the ferrule serves as an appropriate substrate to allow bonding of optical fiber thereto using a quick-curing adhesive agent. Thus, no oven or associated elevated temperatures are necessary in the setting of the fibers reducing complexity of the process and ensuring worker and workplace safety. Yet, the ferrule, itself, remains of a plastic composition, retaining functionality within the fiber optic connector.

What is claimed is:

1. A connector for use with a fiber optic cable comprising:
a housing portion having a first end and a second end, the first end for mating with a second connector, the second end for receiving the fiber optic cable, the housing further including a cavity formed therein;
a strain relief member communicating between the second end of the housing and the fiber optic cable for providing support therebetween;
a lead-in tube disposed in the cavity, the lead-in tube having first fiber passageways formed therein;
a ferrule disposed in the cavity adjacent the lead-in tube, the ferrule including a removable insert, the insert having second fiber passageways formed therein, the insert further being composed of a material which bonds with an acrylic adhesive;
wherein fiber from the fiber optic cable passes from the cable into the cavity at the second end of the housing, said fiber passing through first and second fiber passageways to the first end of the housing for mating with the second connector, said fiber being bonded within the second fiber passageway to the insert by said adhesive.

2. The connector of claim 1 wherein said insert is made from ceramic.

3. The connector of claim 1 wherein said insert is made from glass.

4. The connector of claim 1 wherein said insert is made from metal.

5. The connector of claim 1 wherein said ferrule is made from plastic.

6. The connector of claim 5 wherein said insert is made from ceramic.

7. The connector of claim 1 wherein said adhesive is a two-part acrylic adhesive.

8. The connector of claim 1 wherein said adhesive cure time ranges from about 10 seconds to about 60 seconds.

9. The connector of claim 1 wherein said adhesive cure time ranges is about 30 seconds.
